(19) United States
(12) Patent Application Publication
(10) Pub. No.: US 2006/0163764 A1
(43) Pub. Date: Jul. 27, 2006

(54) Method for producing a thermoplastic resin article

(75) Inventors: Satoshi Hanada, Ichihara-shi (JP); Yoshinori Ohmura, Osaka (JP)

Correspondence Address: FITCH, EVEN, TABIN & FLANNERY, P. O. BOX 65973, WASHINGTON, DC, 20035, US

(73) Assignees: Sumitomo Chemical Company, Limited, Tokyo (JP); Sumika Plastech Co., Ltd., Tokyo (JP)

(21) Appl. No.: 11/336,870

(22) Filed: Jan. 23, 2006

(30) Foreign Application Priority Data
Jan. 25, 2005 (JP) 2005-016685

(51) Int. Cl. B29C 44/12

(52) U.S. Cl. 264/46.8

(57) ABSTRACT

Disclosed is a method for producing a thermoplastic resin article comprising a foamed thermoplastic resin sheet shaped in a predetermined shape and a functional member of thermoplastic resin which stands locally on and is fused with the foamed sheet. In the method, a mold having a molding surface with a recess for forming a functional member therein is used. A foamed thermoplastic resin sheet is stuck on the molding surface by suction so that the recess is sealed with the foamed sheet. Then, molten thermoplastic resin is fed into the recess. Thus, the molten thermoplastic resin is fused with the foamed sheet to form a thermoplastic resin article.

### BACKGROUND OF THE INVENTION

1. Field of the Invention

The present invention relates to methods for producing thermoplastic resin articles.

2. Description of the Related Art

Foamed articles produced by shaping foamed thermoplastic resin sheets are superior in lightweight property, recyclability, heat insulation property, etc. and, therefore, are used for various applications such as automotive components and building or construction materials. Thermoplastic resin articles composed of such foamed articles on which a nonfoamed thermoplastic resin functional member such as rib, boss and hook stands locally on and is fused are also available as automotive interior components or the like. As a method for producing such thermoplastic resin articles, a method including the following steps (1)-(4) is known (see, for example, JP 2001-121561 A):

(1) a step of supplying a foamed thermoplastic resin sheet shaped in advance in a predetermined shape between paired molds, at least one of the molds having a recess with the shape of a functional member to be formed;

(2) a step of closing the molds to seal the opening of the recess with a foamed thermoplastic resin sheet;

(3) a step of feeding molten thermoplastic resin to the recess through a conduit provided in the mold having the recess so as to lead to the recess while keeping the molds closed and keeping the opening of the recess sealed with the foamed thermoplastic resin sheet, thereby fusing the thermoplastic resin with the foamed thermoplastic resin sheet to form a thermoplastic resin article; and

(4) a step of cooling the thermoplastic resin article formed in the step (3) and removing it from the molds.

However, in the aforementioned conventional method, the molten thermoplastic resin fed for forming a functional member may leak from the recess in the mold when a thermoplastic resin article having a complicated configuration is to be produced, for example, when a portion of the article where a functional member is fused is of a curved face.

### SUMMARY OF THE INVENTION

The present invention provides methods for producing a thermoplastic resin molded article comprising a foamed thermoplastic resin sheet shaped in a predetermined shape and a functional member of thermoplastic resin which stands locally on and is fused with the foamed sheet as an article having a good appearance with no resin flash.

The present invention provides a method for producing a thermoplastic resin article comprising a foamed thermoplastic resin sheet shaped in a predetermined shape and a functional member of thermoplastic resin which stands locally on and is fused with the foamed sheet, wherein the method comprises the following steps:

(1) a step of bringing a foamed thermoplastic resin sheet shaped in a predetermined shape into contact with a molding surface of a mold having a recess for shaping a functional member therein, wherein the mold is designed so that suction can be conducted therethrough;

(2) a step of starting suction through the mold, thereby sticking the foamed thermoplastic resin sheet onto the mold so that the recess is sealed;

(3) a step of, at the same time when or after the suction through the mold is started, feeding molten thermoplastic resin into the recess through a conduit provided in the mold so as to lead to the recess, thereby fusing the molten thermoplastic resin with the foamed thermoplastic resin sheet to form a thermoplastic resin article;

(4) a step of, at the same time when or after the feed of the molten thermoplastic resin is stopped, stopping the suction and removing the thermoplastic resin article.

By use of the presently invented methods for producing a thermoplastic resin article comprising a foamed thermoplastic resin sheet shaped in a predetermined shape and a functional member of thermoplastic resin which stands locally on and is fused with the foamed sheet, it is possible to produce a thermoplastic resin article with good appearance without occurrence of resin leakage even when the article to be produced has a complicated shape, for example, when a portion of the article where the functional member is fused is of a curved face.

### BRIEF DESCRIPTION OF THE DRAWINGS

FIG. 1 is a schematic illustration showing the presently invented method for producing a thermoplastic resin article.

FIG. 2 is a schematic Illustration showing a conventional method for producing a thermoplastic resin article.

FIG. 3-(a) is a plan view (rear surface) of a door trim having a rib. FIG. 3-(b) is a cross section taken along the A-A′ line in FIG. 3-(a).

The signs in the drawings have meanings shown below: 1: foamed thermoplastic resin sheet shaped in a predetermined shape; 2: clamp frame; 3: mold; 4: conduit; 5: recess; 6: functional member (rib); and 7: thermoplastic resin article (door trim).

### DESCRIPTION OF THE PREFERRED EMBODIMENTS

The mold used in the present invention is a mold through which suction can be conducted and which has a recess for shaping a functional member therein. The mold may be a convex mold, a concave mold, a flat mold, or the like. The molding surface of the mold is only required to have a configuration such that the foamed thermoplastic resin sheet shaped in advance in a predetermined shape sticks onto at least a region of the molding surface surrounding the recess when suction or supply of compressed air is conducted. In typical cases, a mold is used which has a molding surface the configuration of which is the same as that of the molding surface of a mold used for shaping a foamed thermoplastic resin sheet into a predetermined shape.

In the present invention, a mold is used which is provided with a proper number of recess or recesses with a proper shape depending on the number and shape of the functional member or members to be formed. The mold is provided therein with a conduit for feeding molten thermoplastic resin therethrough into the recess. The molten thermoplastic resin fed in the recess is cooled to form a functional member. The functional member in the thermoplastic resin article produced in the present invention is a parts which has been formed projectingly on the foamed thermoplastic resin sheet. The location and the number of the functional member are not particularly limited. Specific examples of the functional member include ribs having a function of reinforcing a thermoplastic resin article, and bosses, clips, hooks and the like having a function of attaching a thermoplastic resin article to another component.

In the present invention, a mold through which suction can be conducted is used such as a mold having a molding surface at least part of which is composed of sintered alloy and a mold having a molding surface provided, at least in its restricted section, with one or more through holes. The number, location and diameter of the through hole or holes with which the mold is provided are not particularly limited. It, however, is desirable that a suction hole or holes be formed near the recess.

It is also desirable that a suction hole is formed in the wall (side wall, bottom, or both) of the recess. In this case, by sucking through the suction hole in the wall of the recess during the feed of molten thermoplastic resin into the recess, it is possible to make it easy to feed the thermoplastic resin into the recess and it is also possible to reduce the injection pressure needed to feed the thermoplastic resin into the recess. As a result, it is possible to produce a product with good appearance.

The molds have no particular limitations on their material, but from the viewpoints of dimensional stability and durability, they are typically made of metal. From the viewpoints of cost and weight, the molds are preferably made of aluminum or stainless steel. The molds are preferably structured so that the temperature thereof can be controlled by a metallic or ceramic rod heater or heat medium. During the production of a thermoplastic resin article, the molding surfaces of the molds preferably have a temperature from 30 to 80° C., more preferably from 50 to 60° C.

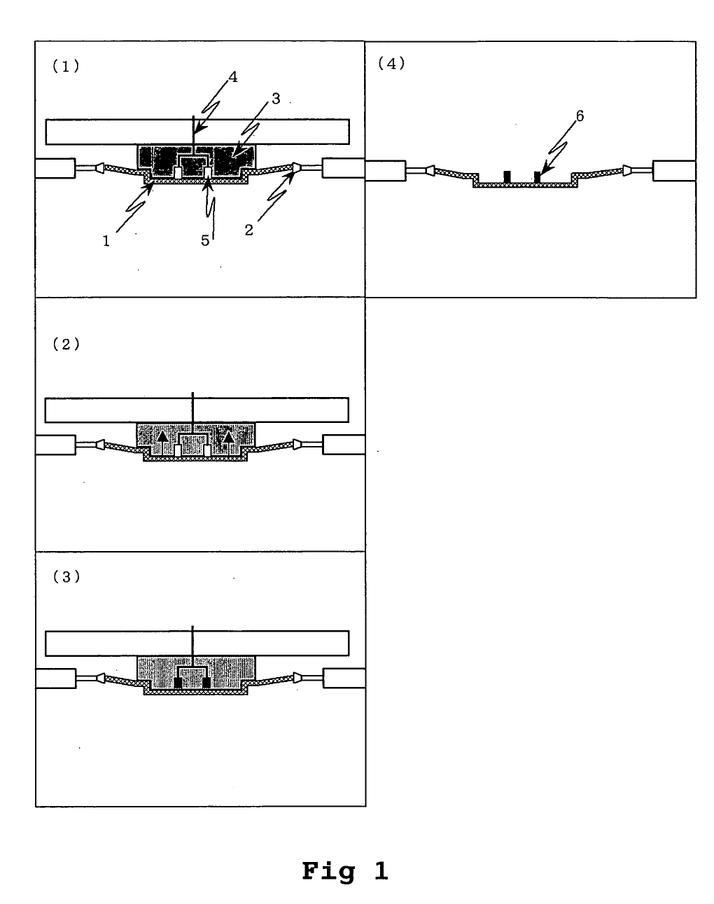

The presently invented method for producing a thermoplastic resin article will be described below with reference to FIG. 1.

In step (1), a foamed thermoplastic resin sheet shaped in advance in a predetermined shape is brought into contact with a molding surface of a mold having a recess for shaping the functional member therein, wherein the mold is designed so that suction can be conducted therethrough. FIG. 1-(1) shows a state where the foamed thermoplastic resin sheet has come in contact with the molding surface of the mold.

In the following step (2), suction through the mold is started and thereby the foamed thermoplastic resin sheet is stuck onto the mold so that the recess is sealed. FIG. 1-(2) shows a state where the foamed thermoplastic resin sheet has stuck on a mold and a recess in the mold has been sealed. The degree of suction is not particularly limited. It is desirable to suck so that the degree of vacuum between the mold and the foamed sheet will settle within the range from −0.05 to −0.1 MPa. The degree of vacuum is a pressure in the space between the mold and the foamed sheet with respect to the atmospheric pressure. For example, “the degree of vacuum is −0.05 MPa” means that the pressure in the space between the mold and the foamed sheet is lower than atmospheric pressure by 0.05 MPa. The degree of vacuum in the space between the mold and the foamed sheet is measured at the opening of a suction conduit formed in the mold.

In the step (3), after the suction is started in the step (2), molten thermoplastic resin is fed to the recess through a conduit provided in the mold so as to lead to the recess. Thus, the molten thermoplastic resin is fused with the foamed thermoplastic resin sheet to form a thermoplastic resin article. FIG. 1-(3) shows a state where the molten thermoplastic resin has been fed into the recess through the conduit provided in the mold so as to lead to the recess while the foamed thermoplastic resin sheet was kept stuck on the mold and the molten thermoplastic resin has been fused with the foamed thermoplastic resin sheet. It is also permitted to feed molten thermoplastic resin into the recess in the mold simultaneously with the start of the suction through the mold in the step (2). By feeding molten thermoplastic resin into the recess in the mold while keeping the foamed sheet stuck on the mold, it is possible to fuse the molten thermoplastic resin with the foamed sheet without causing resin leakage from the recess even when the foamed sheet is of a complicated configuration and, therefore, is hardly stuck to the mold.

At the same time when or after the feed of the molten thermoplastic resin is stopped, the suction is stopped and the resulting article is removed. FIG. 1-(4) shows a state where the article has been removed from the mold.

In the present invention, examples of the thermoplastic resin to be fed into a recess for forming a functional member include olefin-based resin such as homopolymers of olefins having 2 to 6 carbon atoms, e.g. ethylene, propylene, butene, pentene and hexene, olefin copolymers produced by copolymerization of two or more kinds of monomers selected from olefins having form 2 to 10 carbon atoms, ethylene-vinyl ester copolymer, ethylene-(meth) acrylic acid copolymer, ethylene-(meth)acrylic ester copolymer, ester resin, amide resin, styrenic resin, acrylic resin, acrylonitrile-based resin and ionomer resin. The resin for forming a functional member may be composed of either a single kind of resin or a blend of two or more kinds of resins. Olefin-based resins are preferably used from the viewpoints of formability, oil resistance and cost. Propylene-based resins are particularly preferably used from the viewpoint of rigidity and heat resistance of a resulting functional member. In the case of use of a polypropylene resin, a resin having a melt flow rate of from 50 to 100 g/10 min is preferably used in view of the fluidity of resin and the strength of a resulting functional member.

The thermoplastic resin to be fed into the recess for forming a functional member may contain a foaming agent. When a thermoplastic resin containing a foaming agent is used, a foamed functional member is formed. As the foaming agent, either of a chemical foaming agent or a physical foaming agent may be used. Moreover, both types of foaming agents may be used together. Examples of the chemical foaming agent include known thermally decomposable compounds such as thermally decomposable foaming agents which form nitrogen gas through their decomposition (e.g., azodicarbonamide, azobisisobutyronitrile, dinitrosopentamethylenetetramine, p-toluenesulfonyl hydrazide, p,p′-oxy-bis(benzensulphonyl hydrazide); and thermally decomposable inorganic foaming agents (e.g., sodium hydrogencarbonate, ammonium carbonate and ammonium hydrogencarbonate). Specific examples of the physical foaming agent include propane, butane, water and carbon dioxide gas. A thermally decomposable foaming agent is preferably used. In particular, a mixture of azodicarbonamide and sodium hydrogen carbonate is preferably used because use of the mixture makes it easy to form a functional member having a high expansion ratio. The foaming agent may be mixed with the thermoplastic resin by a conventional method. The amount of the foaming agent used is appropriately determined on the basis of the kinds of the foaming agent and resin used so that a desired expansion ratio is achieved. However, 0.5 to 20 parts by weight of foaming agent is normally used for 100 parts by weight of thermoplastic resin.

The thermoplastic resin to be fed into the recess may contain additives. Examples of the additives include filler, antioxidants, light stabilizers, ultraviolet absorbers, plasticizers, antistatic agents, colorants, release agents, fluidizing agents and lubricants. Specific examples of the filler include inorganic fibers such as glass fiber and carbon fiber and inorganic particles such as talc, clay, silica, titanium oxide, calcium carbonate and magnesium sulfate. For enhancing the strength of a functional member or reducing the shrinkage of the thermoplastic resin during its molding, it is desirable to incorporate from 5 to 30% by weight of talc or glass fiber with the thermoplastic resin.

In the present invention, a foamed thermoplastic resin sheet is used which has been shaped in a predetermined shape by a conventional technique such as press forming, vacuum forming, pressure forming, vacuum-pressure forming, etc. Although the foamed thermoplastic resin sheet is not particularly limited with respect to expansion ratio and thickness, typically used is a foamed sheet having an expansion ratio of from 2 to 10 and a thickness of from 1 to 10 mm.

Examples of the thermoplastic resin for forming the foamed thermoplastic resin sheet used in the present invention include olefin-based resin such as homopolymers of olefins having 2 to 6 carbon atoms, e.g. ethylene, propylene, butene, pentene and hexene, olefin copolymers produced by copolymerization of two or more kinds of monomers selected from olefins having 2 to 10 carbon atoms, ethylene-vinyl ester copolymer, ethylene-(meth) acrylic acid copolymer, ethylene-(meth)acrylic ester copolymer, ester resin, amide resin, styrene-based resin, acrylic resin, acrylonitrile-based resin and ionomer resin. These resins may be used solely or two or more of them may be used in combination. Olefin-based resins are preferably used from the viewpoints of shapeability, oil resistance and cost. Propylene-based resins are particularly preferred from the viewpoint of rigidity and heat resistance of resulting articles.

Examples of the propylene-based resins include propylene homopolymers and propylene-based copolymers containing at least 50 mol % of propylene units. The copolymers may be block copolymers, random copolymers and graft copolymers. Examples of the propylene-based copolymers to be suitably employed include copolymers of propylene with ethylene or an α-olefin having 4 to 10 carbon atoms. Examples of the α-olefin having 4 to 10 carbon atoms include 1-butene, 4-methylpentene-1, 1-hexene and 1-octene. The content of the monomer units except propylene in the propylene-based copolymer is preferably up to 15 mol % for ethylene and up to 30 mol % for α-olefins having 4 to 10 carbon atoms. A single kind of propylene-based resin may be used. Alternatively, two or more kinds of propylene-based resin may also be used in combination.

When a long-chain-branching propylene-based resin or a propylene-based resin having a weight average molecular weight of 1×10⁵ or more is used in an amount of 50% by weight or more of the thermoplastic resin forming a foamed layer, it is possible to produce a foamed propylene-based resin sheet having fine cells. Among such propylene-based resins, non-crosslinked propylene-based resins are preferably used because less gel is formed during a process of recycling.

By the long-chain-branching propylene-based resin as used herein is meant a propylene-based resin whose branching index [A] satisfies 0.20≦[A]≦0.98.

One example of the long-chain-branching propylene-based resins having a branching index [A] satisfying 0.20≦[A]≦0.98 is Propylene PF-814 manufactured by Basell Co.

The branching index quantifies the degree of long chain branching in a polymer and is defined by the following formula.
Branching index [A] =[η]_{Br}/[η]_{Lin}

In the formula, [η]_{Br} is the intrinsic viscosity of the long-chain-branching propylene-based resin. [η]_{Lin} is the intrinsic viscosity of a linear propylene-based resin made up of monomer units the same as those of the long-chain-branching propylene-based resin and having a weight average molecular weight the same as that of the long-chain-branching propylene-based resin.

The intrinsic viscosity, which is also called a limiting viscosity number, is a measure of the capacity of a polymer to enhance the viscosity of its solution. The intrinsic viscosity depends particularly on the molecular weight and on the degree of branching of the polymer molecule. Therefore, the ratio of the intrinsic viscosity of a long-chain-branching polymer to the intrinsic viscosity of a linear polymer having a molecular weight equal to that of the long-chain-branching polymer can be used as a measure of the degree of branching of the long-chain-branching polymer. The intrinsic viscosity of a propylene-based resin can be determined by a conventionally known method such as that described by Elliott et al., J. Appl. Polym. Sci., 14, 2947-2963 (1970). For example, the intrinsic viscosity can be measured at 135° C. by dissolving the propylene-based resin in tetralin or orthodichlorobenzene.

The weight average molecular weight (Mw) of a propylene-based resin can be determined by various methods commonly used. Particularly preferably employed is the method reported by M. L. McConnel in American Laboratory, May, 63-75 (1978), namely, the low-angle laser light-scattering intensity measuring method.

One example of the method for producing a high-molecular-weight propylene-based resin having a weight average molecular weight of 1×10⁵ or more by polymerization is a method in which a high molecular weight component is produced first and then a low molecular weight component is produced as described in JP 11-228629 A.

Among long-chain-branching propylene-based resins and high-molecular-weight propylene-based resins, preferred is a propylene-based resin having a uniaxial melt elongation viscosity ratio η₅/η_{0.1} of 5 or more, more preferably 10 or more, measured under the conditions given below at about a temperature 30° C. higher than the melting point of the resin. The uniaxial melt elongation viscosity ratio η₅/η_{0.1} is a value measured at an elongation strain rate of 1 sec⁻¹ using a uniaxial elongation viscosity analyzer (for example, a uniaxial elongation viscosity analyzer manufactured by Rheometrix), wherein η_{0.1} denotes a uniaxial melt elongation viscosity detected 0.1 second after the start of strain and η₅ denotes a uniaxial melt elongation viscosity detected 5 seconds after the start of strain. By using a propylene-based resin having such a uniaxial elongation viscosity property, it is possible to produce a foamed sheet having more minute cells.

As the foaming agent for use in the preparation of the foamed sheet, either a chemical foaming agent or a physical foaming agent may be used. Moreover, both types of foaming agents may be used together. Examples of the chemical foaming agent include known thermally decomposable compounds such as thermally decomposable foaming agents which form nitrogen gas through their decomposition (e.g., azodicarbonamide, azobisisobutyronitrile, dinitrosopentamethylenetetramine, p-toluenesulfonyl hydrazide, p,p′-oxy-bis(benzensulphonyl hydrazide); and thermally decomposable inorganic foaming agents (e.g., sodium hydrogencarbonate, ammonium carbonate and ammonium hydrogencarbonate). Specific examples of the physical foaming agent include propane, butane, water and carbon dioxide gas. Among the foaming agents provided above as examples, water and carbon dioxide gas are suitably employed because foamed sheets produce less deformation caused by secondary foaming during heating in vacuum forming and also because those agents are substances inert under high temperature conditions and inert to fire. The amount of the foaming agent used is appropriately determined on the basis of the kinds of the foaming agent and resin used so that a desired expansion ratio is achieved. However, 0.5 to 20 parts by weight of foaming agent is typically used for 100 parts by weight of thermoplastic resin.

The method for producing the foamed thermoplastic resin sheet shaped in a predetermined shape is not restricted. However, extrusion forming using a flat die (T die) or a circular die is preferred. Particularly preferred is a method in which molten resin is extruded and simultaneously foamed through a circular die and then the extrudate is stretched and cooled over a mandrel or the like. When the foamed sheet is produced by extrusion, it is also permissive that molten resin is extruded through a die, cooled to solidify and then stretched. The foamed sheet may be either a monolayer sheet or a multilayer sheet. However, for preventing cells from bursting during the sheet production, a foamed sheet of multilayer structure having non-foamed surface layers. The resin for forming the non-foamed layer(s) may be the resins provided as examples of the resin for forming the foamed layer. The resin of the non-foamed layer(s) is desirably a resin of a type the same as that of the resin forming the foamed layer. For example, when the foamed layer is made of a propylene-based resin, it is desirable that the non-foamed layer(s) be also made of a propylene-based resin.

The foamed thermoplastic resin sheet shaped in a predetermined shape for use in the present invention may also be a composite sheet prepared by laminating a mono- or multilayer foamed sheet and another material. Such a composite sheet is produced by laminating a foamed sheet and another material by dry lamination, sandwich lamination, heat roll lamination, hot air lamination or the like, followed by shaping into a predetermined shape.

The material which is to be laminated to the foamed sheet is a material which serves to decorate, reinforce or protect the foamed sheet, such as materials in the form of woven fabric, nonwoven fabric, sheet, film, foam, net, etc. Such materials may be made from, for example, thermoplastic resin such as olefin-based resin, vinyl chloride-based resin and styrene-based resin, rubber or thermoplastic elastomer such as polybutadiene and ethylene-propylene copolymer, and cellulosic fiber such as cotton, hemp and bamboo. Those materials may be applied with uneven patterns such as grain pattern, print or dyeing and may be of either a single layer structure or a multiple layer structure.

Foamed thermoplastic resin sheets for use in the present invention may contain additives. Examples of the additives include filler, antioxidants, light stabilizers, ultraviolet absorbers, plasticizers, antistatic agents, colorants, release agents, fluidizing agents and lubricants. Specific examples of the filler include inorganic fibers such as glass fiber and carbon fiber and inorganic particles such as talc, clay, silica, titanium oxide, calcium carbonate and magnesium sulfate.

Thermoplastic resin articles produced by use of the present invention are available as packaging materials such as food containers, automotive interior components, building or construction materials and household electric appliances. The automotive interior components include door trims, ceiling materials, trunk side panels, etc. Automotive interior components composed of thermoplastic resin articles having a rib as a functional member produced by the methods of the present invention have high strength. Thermoplastic resin articles having a boss or a hook as a functional member produced by the methods of the present invention can be attached easily to other automotive components.

### EXAMPLES

The present invention is explained with reference to Examples below. The invention, however, is not limited to the Examples.

### Example 1

A foamed polypropylene sheet having an expansion ratio of 3 times and a thickness of 3 mm (SUMICELLER produced by Sumika Plastech Co., Ltd.) was shaped into the shape of a door trim by use of a female mold and a plug which were designed for shaping a foamed sheet into a door trim form. Using the resulting foamed polypropylene sheet (1) shaped in a door trim form, a thermoplastic resin article was produced by the method illustrated in FIG. 1. The mold (3) used in the following procedures is a mold with a molding surface having a shape the same as that of the molding surface of the female mold used for the shaping of the foamed sheet (1) and being capable of forming the rear face of a door trim. The molding surface has a suction hole and a recess (5) for forming a rib having a width of 2.5 mm and a height of 10 mm as a functional member. The mold has therein a conduit (4) through which molten thermoplastic resin can be fed to the recess. The mold (3) was used while being adjusted to a temperature of 60° C.

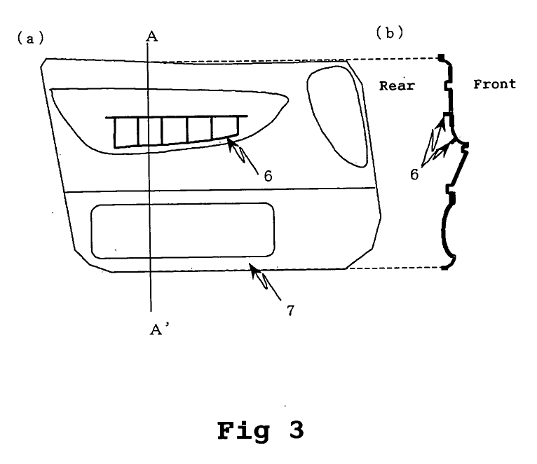

The foamed sheet (1) shaped in a door trim form was fixed in a clamp frame (2) of a vacuum forming machine (VAIM0301 manufactured by Satoh Machinery Works, Co., Ltd.) equipped with an extruder. The mold (3) was brought into contact with the rear side of the door trim made of the foamed sheet (1) held in the clamp frame. Suction through the mold (3) was conducted. Thus, the foamed sheet (1) was stuck onto the mold (3) so as to seal the recess and the degree of vacuum between the mold and the foamed sheet was adjusted to −0.09 MPa. Five seconds after the start of the suction, molten thermoplastic resin at 240° C. (NOBLEN AX568, polypropylene manufactured by Sumitomo Chemical Co., Ltd.; MI=65 g/min) was fed into the recess through the conduit (4) in the mold (3) in 15 seconds. Thus, the recess was filled up with the molten thermoplastic resin. Five seconds after the completion of the feed of the molten thermoplastic resin, the suction was stopped and air was blown by means of a cooling fan to cool the resulting article, which was then removed. The unnecessary end portion was cut away and thereby a door trim having a rib shown in FIG. 3 was produced. No resin leakage occurred at the joint of the rib and the resulting door trim had an excellent appearance.

### Comparative Example 1

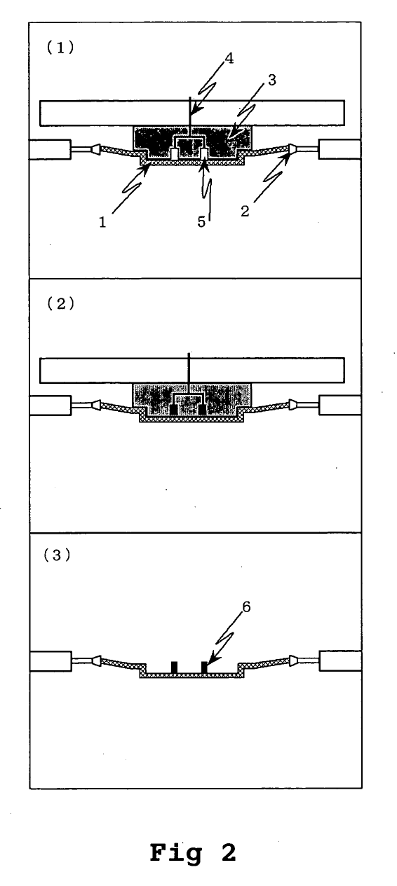

By using a foamed sheet, thermoplastic resin and molds the same as those used in Example 1 and without conducting suction through a mold, a door trim was produced. The outline is shown in FIG. 2.

A foamed polypropylene sheet (1) shaped in advance in a door trim form was fixed in a clamp frame (2) of the vacuum forming machine and a mold (3) was brought into contact with the rear side of the door trim in the clamp frame. Molten thermoplastic resin at 240° C. was fed into a recess through a conduit (4) in the mold (3) in 15 seconds. Thus, the recess was filled up with the molten thermoplastic resin. Air was blown by means of a cooling fan to cool the resulting article. The molds were opened and the article was removed. The unnecessary end portion was cut away and thereby a door trim (7) having a rib (6) was produced. In the resulting door trim having a rib, there was resin leakage at the joint of the rib.

What is claimed is:

1. A method for producing a thermoplastic resin article comprising a foamed thermoplastic resin sheet shaped in a predetermined shape and a functional member of thermoplastic resin which stands locally on and is fused with the foamed sheet, wherein the method comprises the following steps:
(1) a step of bringing a foamed thermoplastic resin sheet shaped in a predetermined shape into contact with a molding surface of a mold having a recess for shaping a functional member therein, wherein the mold is designed so that suction can be conducted therethrough;
(2) a step of starting suction through the mold, thereby sticking the foamed thermoplastic resin sheet onto the mold so that the recess is sealed;
(3) a step of, at the same time when or after the suction through the mold is started, feeding molten thermoplastic resin into the recess through a conduit provided in the mold so as to lead to the recess, thereby fusing the molten thermoplastic resin with the foamed thermoplastic resin sheet to form a thermoplastic resin article;
(4) a step of, at the same time when or after the feed of the molten thermoplastic resin is stopped, stopping the suction and removing the thermoplastic resin article.
